(19) United States
(12) Patent Application Publication
(10) Pub. No.: US 2008/0083115 A1
(43) Pub. Date: Apr. 10, 2008

(54) Method for repairing metal finish layer on surface of electrical connection pad of circuit board

(76) Inventors: Shih-Ping Hsu, Hsin-chu (TW); Chao Wen Shih, Hsin-chu (TW)

Correspondence Address: Mr. Joseph A. Sawyer, Jr.;SAWYER LAW GROUP LLP, Suite 406, 2465 East Bayshore Road, Palo Alto, CA, 94303, US

(21) Appl. No.: 11/544,406

(22) Filed: Oct. 5, 2006

(51) Int. Cl. H01R 9/00

(52) U.S. Cl. 29/842; 29/846

(57) ABSTRACT

A method for repairing a metal finish layer on a surface of an electrical connection pad of a circuit board is provided. Firstly, a circuit board having a plurality of electrical connection pads on a surface thereof is provided, and a plurality of metal finish layers are formed on surfaces of the electrical connection pads, wherein some of the metal finish layers have at least a fault. Then, a micro deposition process is performed on the metal finish layer having the fault using micro droplets. Therefore, a production yield can be improved and a fabrication cost can be reduced as a result.

### FIELD OF THE INVENTION

The present invention relates to a method for repairing a metal finish layer on a surface of an electrical connection pad of a circuit board, and more particularly, to a method for repairing a metal finish layer having a fault on a surface of an electrical connection pad on a circuit board.

### BACKGROUND OF THE INVENTION

Along with the blooming development of electronic technology and miniaturization of electronic products, the fabrication of semiconductor packages becomes very critical. A plurality of conductive traces which is made of copper materials and formed on a surface of a substrate of a semiconductor package is extended to form electrical connection pads which serve to transmit electric signals or serve as power sources. Usually, a metal finish layer such as nickel or gold is formed on an exposed surface of the electrical connection pad, so as to effectively electrically connect other conductive elements such as gold wires, bumps or solder balls to a chip or a circuit board. Furthermore, the metal finish layer is also able to prevent an oxidation layer caused by an external environment from being formed on the surface of the electrical connection pad.

The electrical connection pad can be a wire bonding pad which is electrically connected between a semiconductor chip and a circuit board using gold wires, a bump pad which is electrically connected between a semiconductor flip chip package substrate and a chip, a surface mount technology (SMT) pad which is electrically connected between passive components and a circuit board, or a solder ball pad which is electrically connected between a package substrate and a circuit board. A metal finish layer such as nickel or gold is formed on the surface of the electrical connection pad, so as to prevent the electrical connection pad (usually made by metal copper) which is covered by the metal finish layer from being oxidized by an external environment. Thus, the quality of electrical connection can be ensured for wire bonding, solder bumps, and solder balls formed on the surface of the electrical connection pad.

FIG. 1A to FIG. 1C are schematic diagrams showing a method for forming a metal finish layer on a surface of an electrical connection pad of a circuit board according to prior art. In order to precisely form a metal finish layer on a surface of an electrical connection pad, a solder mask 18 such as green paint is formed a surface of a circuit board 1 which has been previously formed with a patterned circuit layer 12 using printing or coating techniques. Referring to FIG. 1B, the patterned circuit layer 12 formed on the surface of the circuit board 1 comprises a plurality of electrical connection pads 15, and a plurality of openings 180 are formed penetrating through the solder mask 18 to expose the electrical connection pads 15. Referring to FIG. 1C, when forming the nickel or gold metal layer, a metal finish 16 is formed on the surface of the electrical connection pad 15 exposed from the opening 180 of the solder mask 18.

However, in order to meet market requirements, the structure of a semiconductor package needs to be miniaturized and a semiconductor chip is also becoming finer and more highly integrated. A circuit board which serves as a chip carrier is formed with electrical connection pads with a high density, such that the semiconductor chip carried by the chip carrier can be successfully electrically connected to the circuit board. Thus, the highly integrated chip can be well operated to achieve its function and performance, so as to reduce the area of the integrated circuits (IC). Furthermore, packages characterized with a high density and multi-leads such as a ball grid array (BGA) structure, a flip chip structure, a chip size package (CSP) and a multi chip module (MCM) package are gradually becoming the mainstream of the market.

As the integrated circuit of the semiconductor chip has been reduced to 90 nm and the dimension of the package has also been achieved to a dimension similar to that of the chip (about 1.2 times of the chip), research directed to integrated circuits (IC) and other relevant electronic industries has focused on ways to develop a circuit board with fine circuits, a high density and small openings which can be gone with the semiconductor chip. However, if the conductive traces are to be finer, the dimension and the area of the electrical connection pad formed on the substrate and adjacent pitches would have to be also reduced, so that the opening of the solder mask formed at a location corresponding to the electrical connection pad would become insufficiently large enough as a consequence. Thus, the metal material of the metal finish layer cannot be effectively formed on the surface of the electrical connection pad, by which a production yield will be reduced and a fabrication cost will be increased as a result.

Therefore, the problem to be solved herein is to provide a method for repairing a metal finish layer on a surface of an electrical connection pad, by which problems such as a low production yield and a high fabrication cost caused by the defect of the metal finish layer formed on the surface of the electrical connection pad of a prior-art circuit board can be effectively solved.

### SUMMARY OF THE INVENTION

In light of the above prior-art drawbacks, a primary objective of the present invention is to provide a method for repairing a metal finish layer on a surface of an electrical connection pad of a circuit board, by which a production yield can be increased and a fabrication cost can be reduced.

In accordance with the foregoing and other objectives, the present invention proposes a method for repairing a metal finish layer on a surface of an electrical connection pad of a circuit board. Referring to the method, firstly, a circuit board having a plurality of electrical connection pads on a surface thereof is provided, and a plurality of metal finish layers are formed on surfaces of the electrical connection pads, wherein some of the metal finish layers have at least a fault. Then, a micro deposition process is performed on the metal finish layer having the fault using micro droplets.

The fault is a non-formed metal finish layer or an incomplete metal finish layer. The metal finish layer is made of a material selected from the group consisting of gold, nickel, palladium, silver, tin, nickel/palladium, chromium/titanium, nickel/gold, palladium/gold and nickel/palladium/gold.

Further, the electrical connection pad is selected from the group consisting of a wire bonding pad, a bump pad, a surface mount technology (SMT) pad and a ball pad. In the present invention, a micro deposition process is performed using micro droplets to repair the metal finish layer having the fault. Therefore, the metal finish layer can be immediately repaired once the fault has been detected, so as to dramatically improve the production yield and reduce the fabrication cost.

### BRIEF DESCRIPTION OF THE DRAWINGS

The present invention can be more fully understood by reading the following detailed description of the preferred embodiments, with reference made to the accompanying drawings, wherein:

FIG. 1A to FIG. 1C are schematic diagrams showing a method for forming a nickel/gold metal finish layer on a surface of an electrical connection pad of a circuit board according to prior-art; and

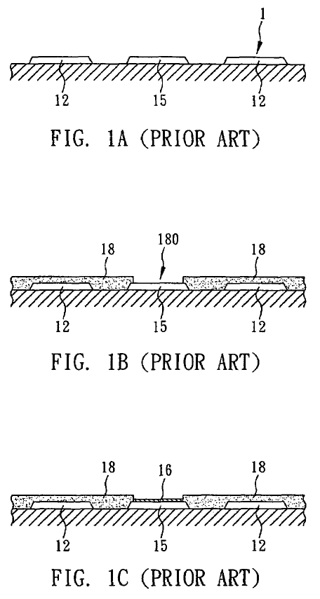

FIG. 2A and FIG. 2B are flow charts showing a method for repairing a metal finish layer on a surface of an electrical connection pad of a circuit board.

### DETAILED DESCRIPTION OF THE EMBODIMENTS

The present invention is described in the following with specific embodiments, so that one skilled in the pertinent art can easily understand other advantages and effects of the present invention from the disclosure of the invention.

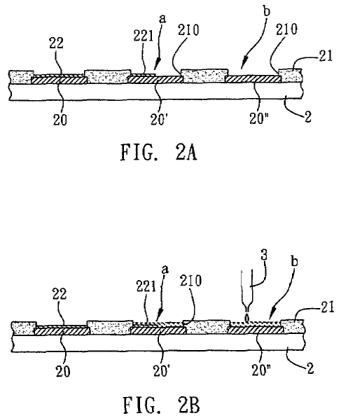

FIG. 2A and FIG. 2B are flow charts showing a method for repairing a metal finish layer on a surface of an electrical connection pad of a circuit board.

Referring to FIG. 2A, firstly, a circuit board 2 having a plurality of electrical connection pads 20 on at least a surface thereof is provided. The electrical connection pads 20, 20′ and 20″ can be a wire bonding pad, a bump pad, a surface mount technology (SMT) pad or a solder ball pad. Then, a solder mask 21 is formed on the surface of the circuit board 2. The solder mask 21 is formed with a plurality of openings 210 to expose the electrical connection pads 20, 20′ and 20″ from the surface of the circuit board 2. Further, a metal finish layer 22 is formed on the electrical connection pad 20, wherein the metal finish layer 22 has a fault. For example, an incomplete metal finish layer 22 is formed on the surface of the electrical connection pad 20′ at a position a on the circuit board 2, or no metal finish layer is formed on the surface of the electrical connection pad 20″ at a position b on the circuit board 2.

Referring to FIG. 2B, a metal layer is formed by a micro deposition process using a micro droplet 3 on the surfaces of the electrical connection pads 20′ and 20″ at the position a and the position b on the circuit board 2. Thus, a metal finish layer 22 is formed on the surfaces of the electrical connection pads 20′ and 20″ to repair the fault, so as to improve a production yield and reduce a fabrication cost. Furthermore, the foregoing metal finish layer is made of a material selected from the group consisting of gold, nickel, palladium, silver, tin, nickel/palladium, chromium/titanium, nickel/gold, palladium/gold and nickel/palladium/gold.

If the foregoing metal finish layer 22 is a single-layered metal, the micro deposition process is performed once using the micro droplet 3. However, if it is a double-layered or multi-layered metal, the micro deposition process is performed twice using the micro droplet 3. Therefore, the metal finish layer 22 having a double-layered metal can be formed on the surface of the electrical connection pad 20. Alternatively, the metal finish layer 22 having a multi-layered metal can also be formed.

In the present embodiment, a metal layer is formed by a micro deposition process using a micro droplet during or after the fabrication of the circuit board (i.e. the treatment of the surface of the circuit board), so as to repair the fault of the metal finish layer.

Accordingly, referring to the method for repairing a metal finish layer on a surface of an electrical connection pad of a circuit board proposed in the present invention, a micro deposition process is performed using a micro droplet to repair the metal finish layer having a fault. Therefore, the method proposed in the present invention is able to effectively repair the metal finish layer having the fault once the fault has been detected, so as to dramatically improve a production yield and reduce a fabrication cost.

The invention has been described using exemplary preferred embodiments. However, it is to be understood that the scope of the invention is not limited to the disclosed embodiments. On the contrary, it is intended to cover various modifications and similar arrangements; for example, the number and locations of resistors and capacitors can be flexibly arranged according to practical requirements. The scope of the claims, therefore, should be accorded the broadest interpretation so as to encompass all such modifications and similar arrangements.

What is claimed is:

1. A method for repairing a metal finish layer on a surface of an electrical connection pad of a circuit board, comprising steps of:
providing a circuit board having a plurality of electrical connection pads on at least a surface thereof, surfaces of the electrical connection pads being formed with a plurality of metal finish layers, wherein some of the metal finish layers have at least a fault; and
performing a micro droplet process to repair the metal finish layer having the fault on the surface of the electrical connection pad.

2. The method for repairing a metal finish layer on a surface of an electrical connection pad of a circuit board of claim 1, wherein the fault is a non-formed metal finish layer or an incomplete metal finish layer.

3. The method for repairing a metal finish layer on a surface of an electrical connection pad of a circuit board of claim 1, wherein the metal finish layer is made of a material selected from the group consisting of gold, nickel, palladium, silver, tin, nickel/palladium, chromium/titanium, nickel/gold, palladium/gold and nickel/palladium/gold.

4. The method for repairing a metal finish layer on a surface of an electrical connection pad of a circuit board of claim 1, wherein the method further comprises a step of forming a solder mask on the surface of the circuit board before forming the metal finish layer on the surface of the circuit board, and the solder mask comprises a plurality of openings to expose the electrical connection pads.

5. The method for repairing a metal finish layer on a surface of an electrical connection pad of a circuit board of claim 1, wherein the electrical connection pad is selected from the group consisting of a wire bonding pad, a bump pad, a surface mount technology (SMT) pad and a ball pad.
